(19) United States
(12) Patent Application Publication
(10) Pub. No.: US 2007/0263513 A1
(43) Pub. Date: Nov. 15, 2007

(54) Optical disk recording device, recording method for optical disk

(76) Inventors: Takuma Tsukuda, Yokohama (JP); Kenji Akahoshi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/527,402

(22) Filed: Sep. 27, 2006

(30) Foreign Application Priority Data
May 12, 2006 (JP) 2006-133207

(51) Int. Cl. G11B 7/00

(52) U.S. Cl. 369/59.11; 369/53.18

(57) ABSTRACT

In a transient state in which the temperature difference of a drive device and a disk surface is great and the temperature of the disk surface changes successively, the issues of making a strategy suited to the temperature of the disk surface appropriate, making the irradiation angle of the laser light appropriate, and making the recording power level appropriate are regarded as problems requiring resolution. The aforementioned problems are solved by respectively detecting the temperatures of the drive device and the disk surface and, based on the same temperature difference, determining an appropriate strategy; and further by adjusting the laser light so as to irradiate at an angle appropriate to the inclination of the disk and irradiating the laser light on the disk; and determining an appropriate power level in response to the temperature of the disk surface.

“The present application claims priority to Japanese Patent Application No. 2006-133207, filed on May 12, 2006, and incorporates the contents thereof by reference.”

### BACKGROUND OF THE INVENTION

1. Field of the Invention

The present invention pertains to an optical disk device which records information on a disk by using a semiconductor laser.

2. Description of the Related Art

As measures against the overheating of optical disk devices, there are methods of controlling the recording waveform (hereinafter called “strategy”). Among the same control methods, there is the method of controlling the time axis direction of the pulse signal waveform, disclosed in e.g. JP-A-2001-297437, and the method of controlling the pulse amplitude (power) of a short pulse, disclosed in e.g. JP-A-2005-182847 and JP-A-2001-143372. Also, there is the method of checking the temperature of the vicinity of the recording position and performing a power calibration, disclosed in e.g. JP-A-2001-34947.

### SUMMARY OF THE INVENTION

In recent years, the development of information recording devices using optical disks (hereinafter, optical disk recording devices are called drive devices). Increases in capacity, increases in speed and reductions in size are advancing, but as another aspect thereof, the heat from the heat generation of the drive device and the ambient temperature exerts a bad influence on the recording quality.

As causes for heat exerting a bad influence on the recording quality, there can be cited the fact that the laser wavelength changes as a function of temperature, that the sensitivity of the signal recording layer of the disk changes as a function of temperature, that the mark/space part ends up becoming warped due to heat accumulation and heat interference, and the like.

When a low-temperature disk is installed on a high-temperature drive device, the temperature of the surface of the disk rises with time and in the end becomes nearly the same as the temperature inside the drive disk. In the state of transition during which the temperature of this disk surface changes, the appropriate recording conditions successively change in response to the disk surface temperature.

However, with the conventional method, there was only one place detecting the temperature, on the disk circumference part, so there has been the problem that it was not possible to record with an appropriate strategy, suited to the transition state of the disk surface temperature.

Also, in the initial stage of the transition state, the disk temporarily ends up getting warped due to the temperature difference between the drive device and the disk surface, so if a tilt adjustment is carried out to adapt to the initial stage of the transition state, the inclination of the disk returns at the end of the transition state, so there has been the problem that the angle of the laser light irradiated on the disk became inappropriate.

Moreover, since the temperature of the disk surface differs between the initial stage of the transition state and the end of the transition state, if a power adjustment is carried out to adapt to the initial stage of the transition state, there has been the problem that the recording power becomes inappropriate due to the fact that the laser light power heat quantity in the initial stage of the transition state and the heat quantity accumulated on the disk surface are added.

Consequently, in the present invention, it is regarded as a problem requiring resolution to record even if the temperature difference between the drive device and the disk surface is great and the disk surface temperature changes successively during a transition state.

The aforementioned problem is solved by respectively detecting the temperatures of the drive device and the disk surface, determining an appropriate strategy in response to the temperatures of the drive device and the disk surface, and more specifically, making the determination based on the value of the difference of the same temperatures and also, by adjusting the laser light so as to be irradiated at an angle appropriate to the inclination of the disk and irradiating laser light on the disk, and moreover, by determining an appropriate power level in response to the temperature of the disk surface.

Being able to record under appropriate recording conditions, one can provide an optical disk recording device in which the reliability has been improved for the user.

### BRIEF DESCRIPTION OF THE DRAWINGS

FIG. 1 is a diagram showing the general configuration of Embodiment 1.

FIG. 2 is a table showing the relationship between temperature information and strategy timing pulses in Embodiment 1.

FIG. 3 is a table showing the relationship between temperature information and the power coefficient in Embodiment 3.

FIG. 4 is a diagram showing the strategy, the recording mark, and binarized reproduction levels, of Embodiment 1.

FIG. 5 is a diagram showing a change in the strategy pulse timing in Embodiment 1.

FIG. 6 is a diagram showing a change in strategy power in Embodiment 3.

FIG. 7 is a diagram showing the general configuration of Embodiment 2.

FIG. 8 is a diagram showing the general structure of Embodiment 3.

FIG. 9 is a table showing the temperature information relationship of Embodiment 3.

### DESCRIPTION OF THE EMBODIMENTS

Hereinafter, an explanation is given using the drawings regarding a disk drive relating to the present invention, taking a rewritable DVD (Digital Versatile Disc) as an example.

### Embodiment 1

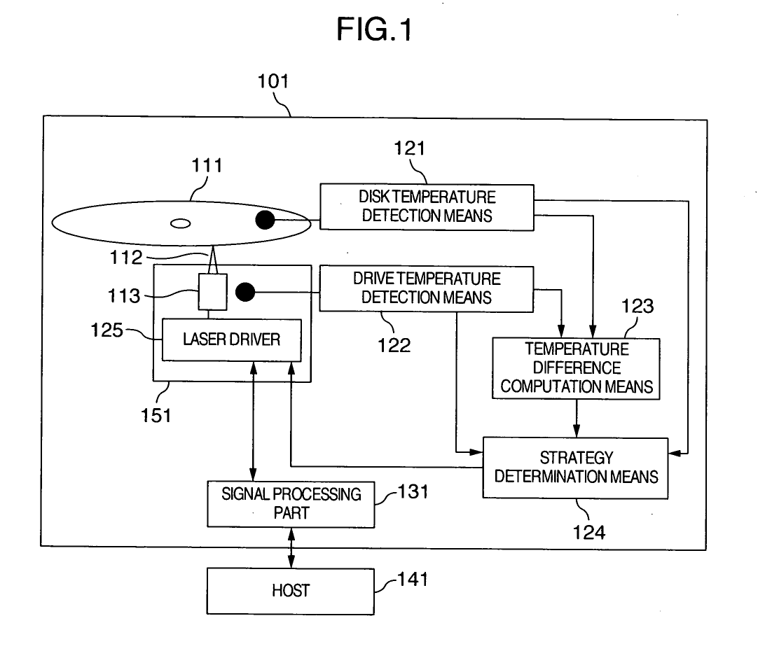

In FIG. 1, the general configuration of a drive device 101 of Embodiment 1 of the present invention is shown.

Drive device 101 comprises an optical disk 111, a semiconductor laser 113 irradiating laser light 112, a disk temperature detection means 121 detecting the temperature of the disk surface, a drive temperature detection means 122 detecting the temperature of the drive device, a temperature difference computation means 123 computing the difference of the temperatures of the disk and the drive device, a strategy determination device 124 determining a strategy suited to the temperatures of the disk and the drive device, a laser driver 125 setting a determined strategy, and a signal processing part 131 processing signals recorded on optical disk 111. Numeral 141 designates a host managing the recorded information.

Numeral 151 designates a pickup which is an embodiment of a recording means which records on the optical disk. Drive temperature detection means 122 is mounted inside pickup 151 having semiconductor laser 113 and laser drive 125. As for this drive temperature detection means 122, it is further preferred that it is provided inside pickup 151 facing optical disk 111.

Disk temperature detection means 121 detects the temperature of the pickup 151 side face of optical disk 111 when optical disk 111 is installed in drive device 101.

By way of example, a thermopile is used as disk temperature detection means 121 and a thermistor is used as drive temperature detection means 122.

The thermistor has a resistance value which changes as a function of the temperature, and the temperature is obtained by making a conversion from the voltage value and the current value on the thermistor.

Moreover, the thermopile is a device which gets warmed up due to the effect of the heat which the infrared radiation has and which detects changes in the electrical properties of a component, based on the increase in component temperature. Using the properties of this thermopile and irradiating infrared radiation on the surface of the optical disk, the temperature of the optical disk surface is detected based on the reflected infrared radiation.

Here, since it is more valid, for the adjustment of the recording waveform and the like based on the temperature difference, to measure the temperature difference between semiconductor laser 113 and the disk surface at a closer position, semiconductor laser 113, disk temperature detection means 121 and drive temperature detection means 122 are arranged at respectively closer locations, and further, it is better for the temperature detection to have disk temperature detection means 121 and drive temperature detection means 122 at opposite positions. For that reason, it is also acceptable with a configuration in which disk temperature detection means 121 and drive temperature detection means 122 are integrated and moved to be matched to recording positions in a radial direction of the optical disk.

Further, the temperature sensor may be another device detecting the temperature, irrespective of whether it is contacting or non-contacting.

Next, the operation of a recording will be explained using FIGS. 1, 2, 4, and 5.

If information to be recorded is supplied from host 141 to signal processing part 131, encoding is carried out to perform scramble, code addition and modulation in signal processing part 131. The scramble randomizes the data to prevent the continuation of a fixed pattern. The code addition adds error correction code in order to carry out detection and correction of errors due to noise or erroneous operation in the communication path. The modulation prevents the continuation of binary number 0's or 1's and converts code by means of a modulation law.

The encoded signal is recorded as mark parts and space parts on the disk in the 3T to 14T range, if the recording operation clock is expressed in periods of 1T. In order to carry out the recording, a strategy corresponding to the mark length and a power level appropriate for the disk recording layer are set.

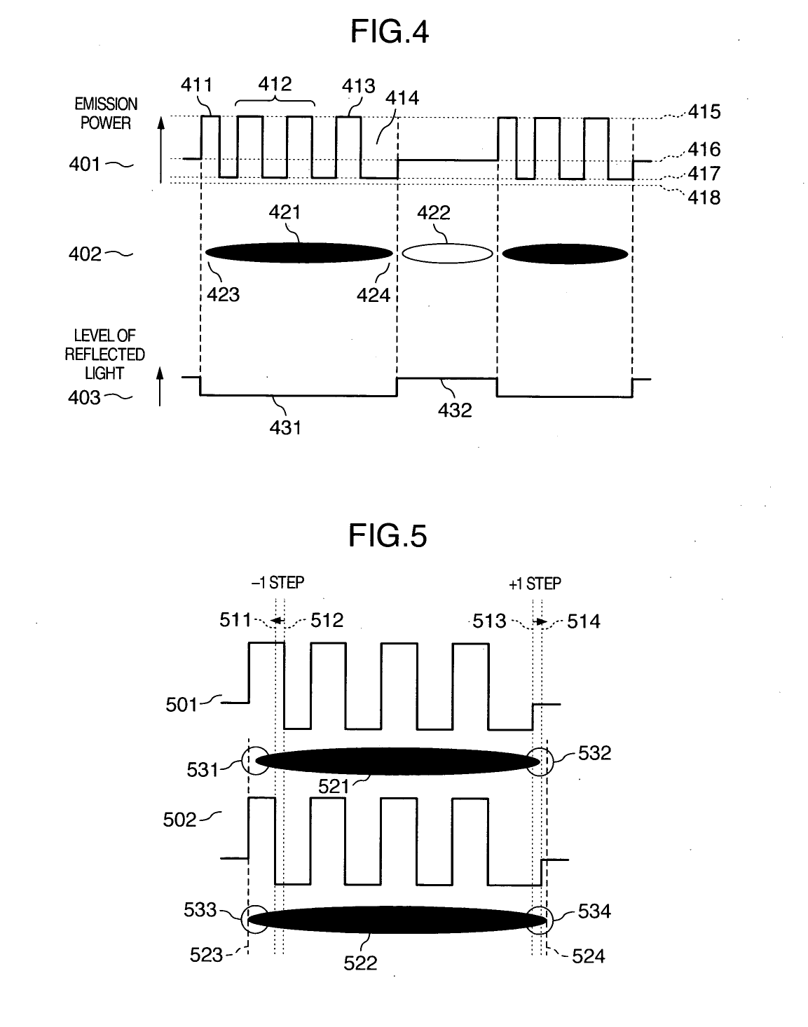

FIG. 4 shows a strategy 401, a mark/space part 402 which can be obtained by the optical disk being irradiated, and a binarized recording level 403 obtained by binarizing the reproduced signal.

The initial emission pulse present in strategy 401 is called a front pulse 411 and the group of pulses following thereafter is called a multipulse 412. Moreover, the last emission pulse is called a final pulse 413 and the low-power pulse after final pulse 413 is called a final cleaning pulse 414. Multipulse 412 emits light in 1T periods, the recording mark length differing by the number of emission pulses. If the recording mark length is taken to be nT (n being a natural number: 3 to 11 and 14), the number of multipulses becomes n−3. Consequently, if front pulse 411 and final pulse 413 are added, the number of strategy emission pulses for a mark length of nT becomes n−1. Further, the number of pulse emissions is an example, another number being acceptable.

Also, the maximum power present in strategy 401 is called a write power level 415, the intermediate power is called an erase power level 416, the lowest power is called a cleaning power level 417, and the level where no light is emitted is called an extinction level 418.

When write power level 415 is irradiated on the optical disk, the temperature of the recording layer increases to or beyond the melting point, and a state is entered in which the atomic arrangement is disordered. When the subsequent cleaning pulse 417 is irradiated, the atomic arrangement remains disordered due to abrupt cooling and enters an amorphous state. As for this amorphous state, a mark 421 is formed since the reflectance becomes lower than for the other state.

Moreover, if erase power 416 is irradiated on the optical disk, since it is maintained for a time leading to a temperature at or above the crystallization temperature, the amorphous state of the mark 421 portion again enters a crystalline state, making it possible to eliminate the mark 421 part, so a space 422 in a crystalline state with high reflectance is formed. Further, even if erase power level 416 is irradiated on space 422, space 422 is formed for a second time. Further, in FIG. 4, there is shown a diagram in which erase power level 416 is higher than cleaning power level 417, but erase power level 416 may be the same as cleaning power level 417.

On a disk where mark 421 and space 422 have been formed, a high reflected light level and a low level can be obtained if read power at a level lower than erase power 416 is irradiated. By binarizing this, there can be obtained binarized reproduction levels: a low level 431 and a high level 432. By making this correspond to the binary numbers 0 and 1, reproduction information can be obtained.

When carrying out this binarization, the low level 431 time period and the high level 432 time period change as a function of the position of a leading edge 423 and a trailing edge 424 which are the ends of mark 421. To obtain appropriate recording quality, it is desirable for the positions of this leading edge 423 and this trailing edge 424 to be in appropriate positions.

Strategy determination means 124 in FIG. 1 determines a strategy based on an identity code M-ID (Manufacture ID) on the disk and the rotary speed of the recording disk, and in response to the disk temperature and the drive device temperature. The same strategy is determined by adapting to the disk temperature and the drive device temperature and is held in advance in a table.

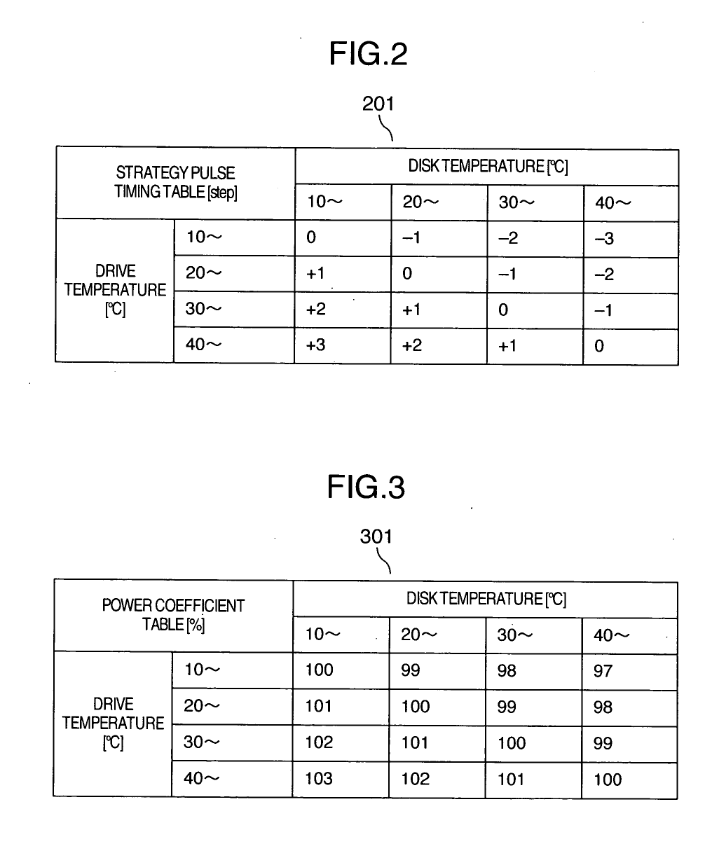

In FIG. 2, there is shown, by way of example, a strategy pulse timing table 201 for determining a strategy in response to the disk temperature and the drive device temperature. This table is prepared separately for each front pulse, multi-pulse, and final pulse. Here, the temperature is respectively divided into ten-degree intervals, and the positions of the strategy emission timing and extinction timing are made to change within the range of −3 to +3 steps from regular predetermined values. Here, one step is a value obtained by dividing T into 1/m (where m is a natural number), the resolution m differing as a function of the properties of laser driver 125. Further, the foregoing is an example, and the temperature intervals need not be in ten-degree units. Also, the timing steps need not be −3 to +3. In other words, in the example of FIG. 2, in the case where the disk temperature is high and the drive device temperature is low, the positions of the strategy emission timing and extinction timing are shortened by several steps, and in the case where the disk temperature is low and the drive device temperature is high, the positions of the strategy emission timing and extinction timing are made several steps longer.

In FIG. 1, the difference in temperature obtained by disk temperature detection means 121 and disk temperature detection means 122 is computed by temperature difference computation means 123 and, based on the temperature difference, the strategy is modified, and an appropriate decision is carried out in strategy determination means 124. Also, the temperature difference may be 0, but it is acceptable to determine a certain level for a temperature difference threshold value, and when the temperature difference exceeds the prescribed value, the determination of an appropriate strategy may be carried out.

In FIG. 5, there is shown a change, being a method example of strategy determination means 124, in emission pulse timing, based on strategy pulse timing table 201. If performing a recording with a low-temperature strategy 501, the strategy is appropriate when the temperature is low, but if the temperature of the disk becomes high, the positions of a first leading edge 531 and a first trailing edge 532 become inappropriate due to the influence of heat accumulation. Accordingly, the time of irradiating cleaning power level 417 in FIG. 4 is lengthened in order to ensure sufficient cooling.

As for an instance which can be cited as an example of the influence of heat accumulation, there is the phenomenon that the recorded mark ends up shrinking due to the fact that a greater heat quantity than normally is added. That is a phenomenon which occurs because the recording layer, after reaching the melting point, cools down slowly.

In order to solve this, a first position 512 of the light emission launch in front pulse 411 in FIG. 4 is advanced one step and changed into a second position 511 of the light emission launch. Also, a first cleaning pulse termination position 513 of final cleaning pulse 414 is delayed by one step and changed into a second cleaning pulse termination position 514. By means of a high-temperature strategy 502 modified in this way, a second mark 522 is recorded. The positions of this second leading edge 533 and second trailing edge 534 becomes an appropriate leading edge position 523 and an appropriate trailing edge position 524 which are appropriate edge positions, so the mark is formed at an appropriate position.

Further, an illustration by example has been given regarding the launch position of front pulse 411 and the termination position of final cleaning pulse 414, but launch positions and termination positions for pulses other than that are acceptable, and the number of steps by which modifications are carried out may be different from 1. Also, first mark 521 is smaller than second mark 522, but it may be bigger. What has an effect on the improvement on the recording quality is in particular that the front pulse width and the cleaning width after the final pulse are changed, rather than changes in the intermediate pulse widths.

By proceeding in this way, the determined strategy is set by laser driver LDD (Laser Diode Driver) 125. And then, in response to the setting of the LDD, laser light 112 is irradiated by semiconductor laser 113. By making an implementation in the way mentioned above, it is possible to determine a strategy matching the temperature of the disk, and an appropriate recording is possible.

### Embodiment 2

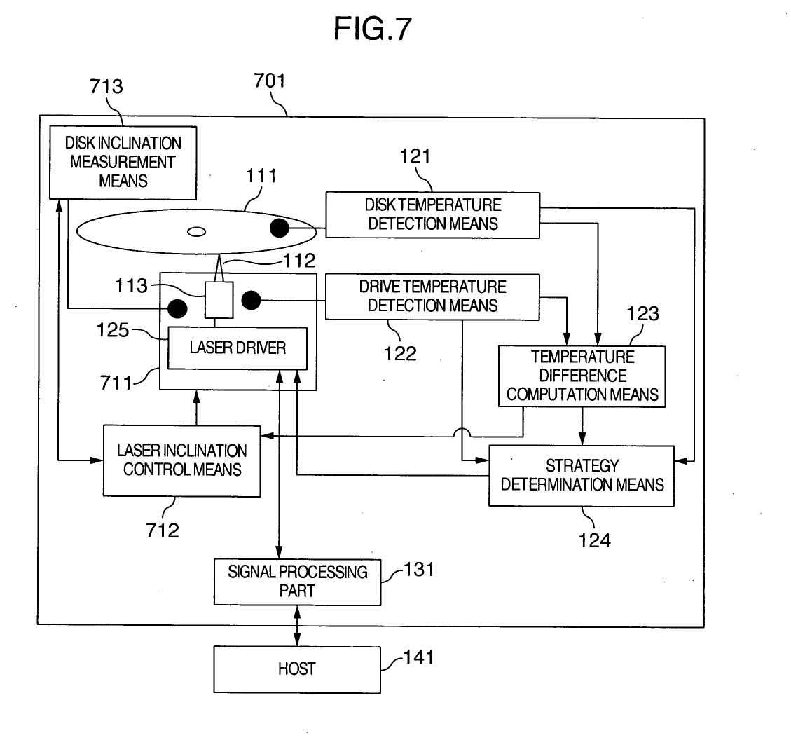

In FIG. 7, the general configuration of a drive device 701 in Embodiment 2 of the present invention is shown.

The basic configuration is the same as that of Embodiment 1 in FIG. 1, but in addition thereto, the embodiment comprises

a three-dimensional pickup 711 capable of changing the irradiation angle of laser light 112, a laser inclination control means 712 controlling the irradiation angle of the laser light, and a disk inclination measurement means 713 measuring the inclination of the disk. The basic operation is the same as that of Embodiment 1 in FIG. 1. The temperature difference obtained by means of disk temperature detection means 121 and drive temperature detection means 122 is computed by temperature difference computation means 123. Also, by means of laser inclination control means 712, an adjustment is carried out so that laser light 112 can irradiate on optical disk 111 at an appropriate angle. While observing the surface temperature of the disk and the temperature of the drive device, the temperature difference is obtained and the conditions for recording appropriately are obtained and, further, the inclination of the disk is measured and adjusted to enable irradiation at a more appropriate angle. Also, it is acceptable to determine a temperature difference threshold value and, when the temperature exceeds the prescribed value, carry out the determination of an appropriate strategy, and make an adjustment so that light can be irradiated at an appropriate angle, based on the inclination of the disk.

The adjustment method irradiates laser light 112 on the surface of optical disk 111 while changing the angle of three-dimensional pickup 711 and, while measuring the inclination of optical disk 111 with disk inclination measurement means 712, takes the angle at which the return light of the laser is a maximum to be the appropriate irradiation angle. The adjustment is implemented at least at two points on a path from the inner circumference of optical disk 111 to the outer circumference.

By making an implementation in the way mentioned above, laser light can be irradiated on the disk at an appropriate angle and it is possible to record appropriately, even if there temporarily arises an inclination of the disk based on the temperature difference between the disk and the drive device.

### Embodiment 3

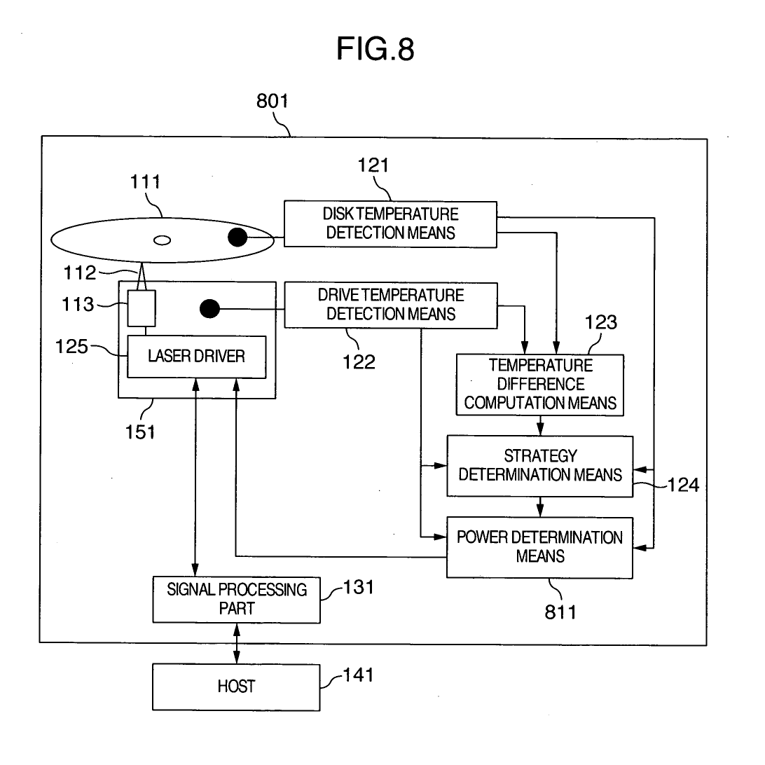

In FIG. 8, the general configuration of a drive device 801 in Embodiment 3 of the present invention is shown. The basic configuration is the same as that of Embodiment 1 in FIG. 1, but in addition thereto, the embodiment comprises a power level determination means 811 determining the power level. The basic operation is the same as that of Embodiment 1 in FIG. 1. The temperature difference obtained by means of disk temperature detection means 121 and drive temperature detection means 122 is computed by temperature difference computation means 123. Also, the power level is determined so as to become an appropriate power level by means of the temperature difference, and it is acceptable to determine a threshold value for the temperature difference and, when the temperature difference exceeds the prescribed value, to determine the power level so that it becomes an appropriate power level.

As a first example of determining the power level, OPC (Optimum Power Control) can be cited. This consists in performing the recording while gradually changing the power level for each sector in the OPC domain of the disk and reading the recorded portions. From the values of recording performance indicators such as the modulation factor, asymmetry, or jitter obtained from the read signal, the power level of well recorded sectors is selected. The power level may be approximated with a quadratic curve or a curve of higher degree and taking the appropriate power level to be the value obtained therefrom. Also, the recording performance indicator value may be any value capable of objectively evaluating the performance.

Also, as a second example of determining the power level, there can be cited the method of preparing a table 301, as in FIG. 3, of power coefficients with respect to a previously obtained and determined pre-obtained power level and obtaining the appropriate power level by multiplying the same pre-obtained power level by a power coefficient. This coefficient is a coefficient which becomes appropriate in response to the disk temperature and the drive device temperature. In other words, in the example of FIG. 3, the recording power is obtained by applying, in the case where the disk temperature is high and the drive device temperature is low, a coefficient which is smaller by several percent to the previously obtained and determined pre-obtained power level, and by applying, in the case where the disk temperature is low and the drive device temperature is high, a coefficient which is greater by several percent to the pre-obtained power level.

Alternatively, this coefficient, as shown in a power coefficient determination means 901 of FIG. 9, may be obtained from the disk surface temperature T and the melting point Tm. Taking as the reference the time when the drive device temperature and disk surface temperature, in a state where the temperature of the disk surface has risen and stabilized, have entered a steady state, the ratio Axy of the difference Dx of the disk surface temperature Tx at that time and the melting point Tm,

Dx=Tm−Tx,

and the difference Dy of the disk surface temperature Ty during a transient state of the temperature and the melting point Tm,

Dy=Tm−Ty,

is given by

Axy=Dy/Dx,

and it is acceptable to set Axy to be multiplied by some coefficient α in power coefficient table 301.

Further, the delimitation, upper and lower limits, and coefficients of the disk temperature and the drive device temperature in power coefficient table 301 may have values other than these.

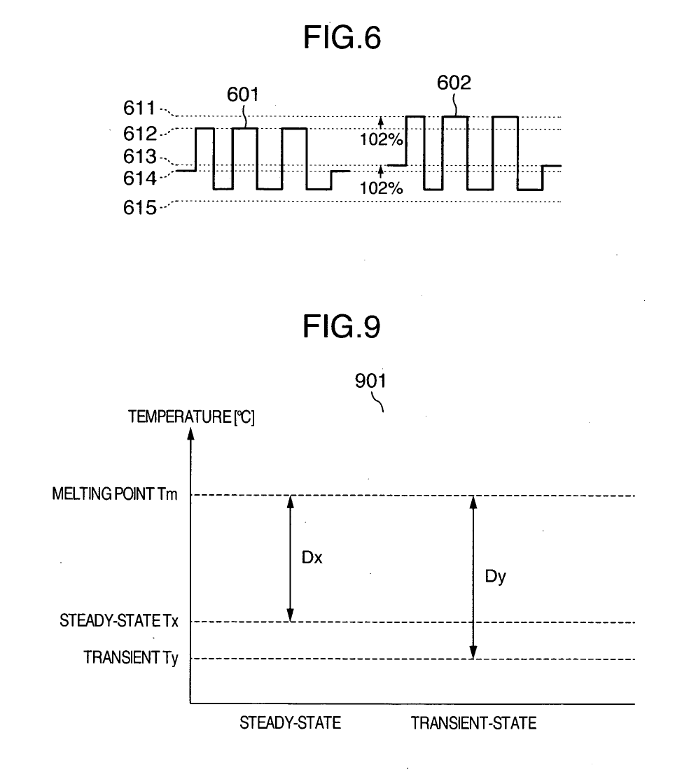

In FIG. 6, there is shown a diagram in which the pre-obtained power level is multiplied by a power coefficient. A first strategy 601 is emitted with a first write power level 612 and a first erase power level 614. By the fact that the power coefficient of 102%, taking as the reference extinction power level 615, is multiplied with the pre-obtained power level, a second strategy 602 is formed by raising the power of first write power level 612 to a second write power level 611 and of first erase power level 614 to a second erase power level 613. Further, in the example, the coefficient is 102%, but values other than that are acceptable. And then, when an appropriate power level has been determined, the value is set in laser driver 125 and, in accordance with the same setting value, semiconductor laser 113 irradiates laser light 112 on optical disk 111 to make a recording. By making an implementation in the way mentioned above, it is possible to record appropriately with a power level suited to the temperature of the disk.

The aforementioned description was made regarding the embodiments, but the present invention is not limited thereto, and the fact that it is possible to carry out various changes and corrections within the scope of the spirit and the appended claims of the present invention is apparent to a person skilled in the art.

1. An optical disk recording device carrying out recording of information by irradiating laser light on an optical disk, comprising:
a first temperature detection means for detecting the temperature of the surface of the optical disk;
a second temperature detection means for detecting the temperature of a recording means irradiating laser light and recording on the optical disk;
a temperature difference computation means for computing the temperature difference between the optical disk surface temperature and the recording means temperature respectively from said first and second temperature detection means; and
a recording waveform determination means for determining the recording waveform in response to the temperature difference obtained with said temperature difference computation means;
wherein said recording means records on said optical disk using the recording waveform determined with said recording waveform determination means.

2. The optical disk recording device according to claim 1, wherein:
said recording waveform is a multipulse; and
said recording waveform determination means changes the pulse width of the front pulse or the final pulse of said multipulse by means of said temperature difference.

3. The optical disk recording device according to claim 2, wherein
said pulse width change is carried out using a table provided in advance and showing values to increase or decrease the pulse width, based on said temperature difference.

4. The optical disk recording device according to claim 1, having a laser power determination means determining the laser irradiation power level suited to the temperature difference, changing the irradiation power level of the laser light, and irradiating laser light on the face of the optical disk.

5. The optical disk recording device according to claim 4, wherein said laser power determination means performs power determination using a table provided in advance and showing coefficients to increase or decrease the power, based on said temperature difference.

6. The optical disk recording device according to claim 4, wherein said laser power determination means performs power determination using a ratio of the temperature when the disk surface temperature has entered a steady state and a temperature during a transient state.

7. The optical disk recording device according to claim 1, provided with
a disk inclination measurement means measuring the inclination of the optical disk and
a laser inclination control means controlling the irradiation angle of the laser light; and
irradiating on the optical disk by changing the irradiation angle of the laser light.

8. The optical disk recording device according to claim 1, wherein said recording waveform determination means, when said temperature difference exceeds a prescribed value, determines said waveform in response to the temperature difference obtained with the temperature difference computation means.

9. The optical disk recording device according to claim 1, detecting the temperature at positions, at which are detected the temperatures of the first temperature detection means detecting the temperature of the said optical disk surface and the second temperature detection means detecting the temperature of the recording means which irradiates laser light to record on the optical disk, which are opposite in a radial direction of the optical disk.

10. The optical disk recording device according to claim 1, wherein the recording means recording on said optical disk by irradiating laser light is a pickup and has said second temperature detection means on the optical disk face side of the pickup.

11. An optical disk recording method carrying out recording of information by irradiating laser light on an optical disk, comprising the steps of:
detecting the temperature of an optical disk surface;
further detecting the temperature of the recording means which records on the optical disk by irradiating laser light;
computing the temperature difference between said detected optical disk surface temperature and recording means temperature;
determining the recording waveform in response to said temperature difference; and
recording on said optical disk using said determined recording waveform.

12. The optical disk recording method according to claim 11 wherein, when said temperature difference exceeds a prescribed value, the recording waveform is determined in response to said temperature difference and recording is carried out on said optical disk using said determined recording waveform.

13. The optical disk recording method according to claim 11 wherein, when said temperature difference exceeds a prescribed value, the inclination of the optical disk is measured and irradiation is carried out by changing the irradiation angle of the laser light with respect to the inclination of the optical disk.

14. The optical disk recording method according to claim 11 wherein, when said temperature difference exceeds a prescribed value, the irradiation power level of the laser light is changed and laser light is irradiated on the optical disk face.

15. An optical disk recording method of carrying out recording of information by irradiating laser light on an optical disk, comprising the steps of:
detecting the temperature of an optical disk surface;
further detecting the temperature of the recording means which records on the optical disk by irradiating laser light;
computing the temperature difference between said detected optical disk surface temperature and recording means temperature; and
recording on said optical disk by shortening the positions of the emission timing and extinction timing of said recording waveform by several steps, in the case where the disk temperature is high and the drive device temperature is low, and lengthening the positions of the emission timing and extinction timing of said recording waveform by several steps, in the case where the disk temperature is low and the drive device temperature is high.

16. An optical disk recording method of carrying out recording of information by irradiating laser light on an optical disk, comprising the steps of:
detecting the temperature of an optical disk surface;
further detecting the temperature of the recording means which records on the optical disk by irradiating laser light;
computing the temperature difference between said detected optical disk surface temperature and recording means temperature; and
applying a coefficient which is smaller by several percent to the power level of the recording waveform, in the case where the disk temperature is high and the drive device temperature is low, and applying a coefficient which is greater by several percent to the power level of the recording waveform, in the case where the disk temperature is low and the drive device temperature is high, to obtain the power level of the recording waveform.

17. An optical disk recording method of carrying out recording of information by irradiating laser light on an optical disk, comprising the steps of:
detecting the temperature of an optical disk surface;
further detecting the temperature of the recording means which records on the optical disk by irradiating laser light;
computing the temperature difference between said detected optical disk surface temperature and recording means temperature; and
recording on said optical disk, with a waveform for which the cooling period after the final pulse of the recording waveform has been changed by several steps to lengthen the cooling period, in the case where the disk temperature is high and the drive device temperature is low, and with a waveform for which the cooling period after the final pulse of the recording waveform has been changed by several steps to shorten the cooling period, in the case where the disk temperature is low and the drive device temperature is high.
